(19) United States
(12) Patent Application Publication
(10) Pub. No.: US 2008/0246996 A1
(43) Pub. Date: Oct. 9, 2008

(54) IMAGE FORMING APPARATUS AND IMAGE FORMING METHOD

(75) Inventor: Tomoaki Kubo, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/696,492

(22) Filed: Apr. 4, 2007

(51) Int. Cl. G06K 15/00

(52) U.S. Cl. 358/1.16

(57) ABSTRACT

Information about a component in an image forming apparatus, such as the remaining life span thereof, is written into a memory attached to the component so as not to exert influences on a computation processing work by the image forming apparatus, such as a copying operation.

### BACKGROUND OF THE INVENTION

1. Field of the Invention

The present invention relates to an image forming apparatus that manages replacement information of respective components forming the image forming apparatus appropriately so as not to exert influences on control processing of the image forming apparatus and to an image forming method.

2. Description of the Related Art

For an image forming process device in an image forming apparatus, respective components forming the device have been made into units, and when the respective components reach their end of life or when the components break down, they are replaced in the form of a unit.

Accordingly, life span information, consumed amount information, failure information, attribute information, identification information, and so forth of a recycle unit, such as a process cartridge used in an image forming apparatus, and components in the unit are stored in a non-volatile memory provided to an image forming apparatus, a management device connected to the image forming apparatus, the unit or the like, so as to be used as information to manage the units and consumable supplies (for example, JP-A-2001-242752).

In a case where a printer is given as a device of interest, there is disclosed a technique by which memories are provided to both the image forming apparatus main body and a component that needs replacing, and information is written sequentially for each print job or the like into the memory on the main body side, while information is written into the memory of a component that needs replacing at timing at which a component replacement mode starts or power supply to the main body is shut OFF (for example, JP-A-2003-19815).

In addition, there has been a system that sets the recycle contents of units, such as replacement, replenishment, cleaning, repairing, and so forth of consumable supplies using the life span information and consumption amount information of the consumable supplies (for example, JP-A-10-216689).

As has been described, in a case where a time when components in the image forming apparatus need replacing is notified according to the management information of the components by means of a display on the liquid crystal panel or the like, the information about a given component, for example, the remaining life span, has to be written and saved in the memory provided to the apparatus main body or the component, the hard disc, or the like.

According to the technique disclosed in JP-A-2003-19815 cited above, information is written into the memory on the component side at the timing at which the component replacement mode starts or power supply to the main body is shut OFF. This technique, however, has a possibility that the component is removed or power supply is shut OFF manually by the user at unexpected timing. In such a case, there is a risk that memory access is cut off during memory writing on the component side. In general, cutting off access during the memory writing possibly causes a writing error or memory corruption.

### BRIEF SUMMARY OF THE INVENTION

In aspect of the present invention, an image forming apparatus includes: an image forming process device used to form an image; a memory that engages with a replaceable component in a component unit forming the image forming process device and stores data about the replaceable component; timing setting means for setting writing timing at which the data is written into the memory for the data to be stored therein; writing instructing means for giving an instruction to write the data into the memory at timing set by the timing setting means; and control means for controlling the image forming process device, wherein the timing setting means inhibits writing of the data into the memory during an image forming process.

### DESCRIPTION OF THE DRAWINGS

FIG. 1 is a view schematically showing the configuration of an image forming apparatus according to one embodiment of the invention;

FIG. 2 is an explanatory view schematically showing the relation of replaceable components in the image forming apparatus;

FIG. 3 is a block diagram of a control system in the image forming apparatus;

FIG. 4 is a timing chart used to describe writing timing to component non-volatile memories of replaceable components shown in FIG. 2; and

FIG. 5 is a flowchart showing the procedure of a writing action to the component non-volatile memories of the replaceable components shown in FIG. 2.

### DETAILED DESCRIPTION OF THE INVENTION

Throughout this description, the embodiments and examples shown should be considered as exemplars, rather than limitations on the apparatus and methods of the present invention.

Hereinafter, one embodiment of the invention will be described with reference to the drawings.

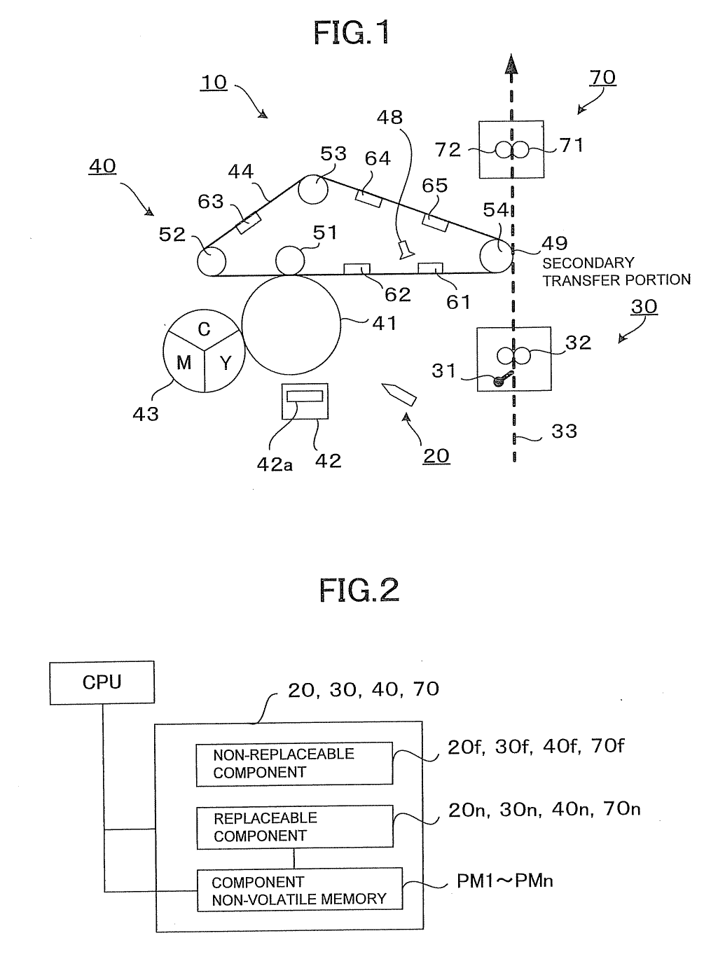

FIG. 1 is a schematic view schematically showing the configuration of an image forming apparatus. An image forming apparatus 10 has a laser unit 20, a paper carrying unit 30, a developing process unit 40, and a fixing unit 70 as an image forming process device.

The laser unit 20 irradiates a laser beam onto a rotating photoconductive drum 41 in the developing process unit 40 according to image data given thereto and thereby forms an electrostatic latent image on the photoconductive drum 41.

The paper carrying unit 30 has a registration switch 31, a registration roller pair 32, and a recording paper carrying path 33. The registration switch 31 of the paper carrying unit 30 detects that a sheet of recording paper is supplied to the recording paper carrying path 33 appropriately. The registration roller pair 32 sends a sheet of recording paper to a secondary transfer portion along the recording paper carrying path 33 at appropriate timing in agreement with the position of toner images having been transferred onto a transfer belt 44 so as to be superimposed one on another. In this example, a portion where a roller 54 faces the carrying path 31 forms the secondary transfer portion 49. In the secondary transfer portion 49, toner images having been transferred onto the transfer belt 44 are transferred (secondary transferred) onto a sheet of recording paper at an appropriate position. The toner images transferred onto the sheet of recording paper are sent to the fixing unit 70 to be fixed on the sheet of recording paper.

A sensor (not shown) that detects jamming of a sheet of recording paper is provided at a specific point in the paper carrying unit 30. In the event that jamming of a sheet of recording paper is detected by the sensor, the paper carrying unit 30 stops and a detection result by the sensor is written into component non-volatile memories PM1 through PMn, the content of which is displayed on a control panel (not shown).

In a case where a marker position sensor 48 fails to detect any of markers in this example, the image forming apparatus 10 stops color image formation and allows only monochromatic image formation (image formation in black or in one color other than black when needed). In the case of monochromatic image formation, the registration between the toner images and a sheet of recording paper is performed without the use of a marker. To be more specific, because the velocities of the photoconductive drum 41 and the transfer belt 44 and a distance from the registration roller pair 32 to the secondary transfer portion are known in advice, triggered by the start of laser beam irradiation by the laser unit 20, a sheet of recording paper is sent to the secondary transfer portion 49 by driving the registration roller pair 32 in response to the timing at which toner images formed on the photoconductive drum 41 reach the secondary transfer portion 49 by way of the transfer belt 44, so that the toner images are transferred (secondary transferred) onto the sheet of recording paper.

The developing process unit 40 has the photoconductive drum 41, a developing unit 42 provided with a developing device 42a (capable of performing development in black) , a revolver 43 rotating as needed and provided with developing devices C, M, and Y capable of performing development in cyan, magenta, and yellow, respectively, the transfer belt 44 to which markers 61, 62, 63, 64, and 65 are attached, rollers 51, 52, 53, and 54, and the marker position sensor 48.

The photoconductive drum 41 described above is rotated by unillustrated various devices disposed on the periphery of the photoconductive drum 41 to enable an image to be formed thereon.

The developing device 42a of the developing unit 42 develops an electrostatic latent image for black formed on the photoconductive drum 41 into a toner image in black by applying toner particles in black to the electrostatic latent image. The revolver 43 rotates the developing devices C, M, and Y to let them face the photoconductive drum 41 sequentially for cyan, magenta, and yellow as colors in which electrostatic latent images have to be developed, and develops electrostatic latent images for cyan, magenta, and yellow formed on the photoconductive drums 41 sequentially into toner images in cyan, magenta, and yellow by applying toner particles in cyan, magenta, and yellow, respectively, to the electrostatic latent images.

The transfer belt 44 rotates while being supported on the rollers 51, 52, 53, and 54 and undergoes primary transfer of toner images on the photoconductive drum 41 at the transfer reference position which is the position at which the photoconductive drum 41 and the roller 51 oppose each other. In a case where the primary transfer is the transfer for a color image, toner images in the respective colors are transferred onto the transfer belt 44 at the same transfer reference position to be superimposed one on another. The transfer reference position can be set by detecting any one of plural markers 61, 62, 63, 64, and 65 attached to the transfer belt 44 by the marker position sensor 48.

The fixing unit 70 has a rotating heating member, for example, a heat roller 71. The heat roller 71 and a press roller 72 as a pressure member are provided at top and bottom in a state where they have a carrying path of a sheet of recording paper as a fixed material in between. The press roller 72 comes into contact with the surface (outer peripheral surface) of the heat roller 71 in a pressurizing state and rotates together with the heat roller 71, so that it takes a sheet of recording paper into a space between the self and the heat roller 71 to apply a pressure to the sheet of recording paper. In this instance, as heat of the heat roller 71 is transmitted to the sheet of recording paper, developing agents on the sheet of recording paper melt and such melted developing agents fix on the surface of the sheet of recording paper.

The heat roller 71 is formed by covering a metal member with a surface member (mold release layer, such as PTEF and PFA), and is driven to rotate in a clockwise direction. The press roller 72 is formed by covering the periphery of a cored bar with silicon rubber or fluorocarbon rubber and rotates in a counterclockwise direction.

As is shown in the schematic view of FIG. 2, the units including the laser unit 20, the paper carrying unit 30, the developing process unit 40, and the fixing unit 70 forming the image forming apparatus shown in FIG. 1 are formed by including non-replaceable components 20f, 30f, 40f, and 70f, and replaceable components 20n, 30n, 40n, and 70n, respectively, and are provided with component non-volatile memories PM1 through PMn that record therein individual information about the replaceable components 20n, 30n, 40n, and 70n, respectively. The component non-volatile memories PM1 through PMn are independently connected to a CPU described below.

The individual information referred to herein means, for example, ID's (a device type code plus an individual code) of the respective replaceable components 20n, 30n, 40n, and 70n, condition information indicating a condition of being new, in use, broken down, or at the end of life, an actual usage performance value D (the number of use times=the number of printed sheets), a set life span value (a life span value by design), and so forth. It should be noted that the set life span value (the life span value by design) varies from component to component.

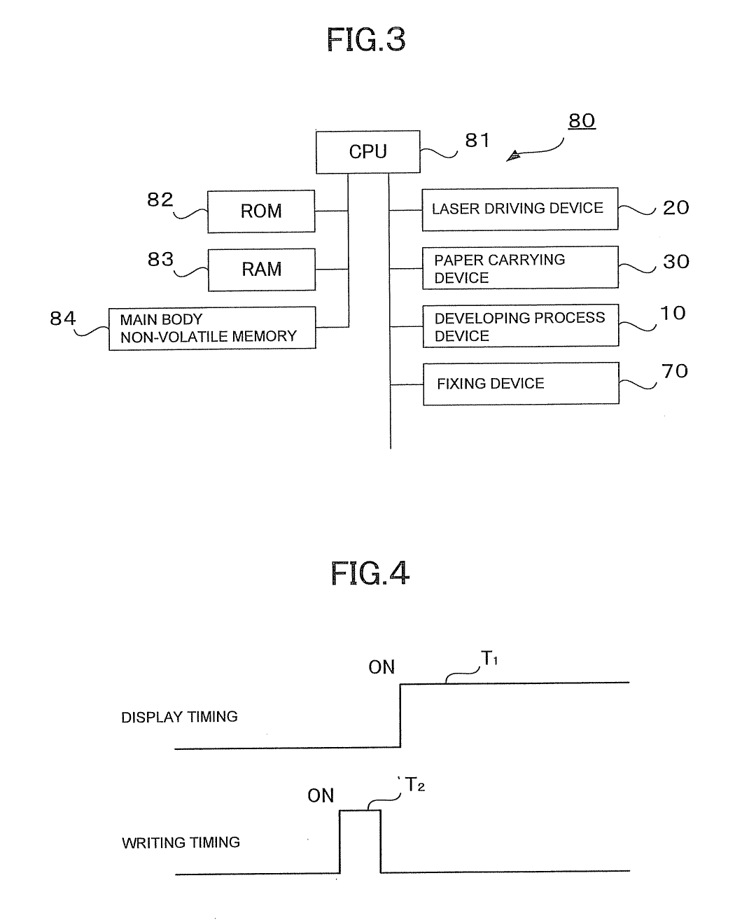

A control unit in the image forming apparatus will now be described briefly with reference to the block diagram of FIG. 3. That is, a CPU 81 functioning as an engine of a control unit 80 is connected to a ROM 82, a RAM 83, and a main body non-volatile memory 84 as well as the developing process unit 40, the laser unit 20, the paper carrying unit 30, and the fixing unit 70 shown in FIG. 1.

The CPU 81 performs control on the control unit 80. Actions placed under this control include control on writing timing to the component non-volatile memories PM1 through PMn (timing setting means) and control on data writing into the component non-volatile memories PM1 through PMn at the set timing (writing instructing means).

The ROM 82 stores a control program of the control unit 80. The RAM 83 is a work memory used by the CPU 81. The main body non-volatile memory 84 saves information about the overall system of the image forming apparatus 10 by the function of the non-volatile memory. According to these, the control on the laser unit 20, the control on the paper carrying unit 30, the control on the developing process unit 40, and the control on the fixing unit 70 are performed in the control unit 80.

The component non-volatile memories PM1 through PMn and the main body non-volatile memory 84 mean a data readable and writable memory element or memory device capable of saving data without an electric supply from the outside, such as a contact-type non-volatile memory, a non-contact-type non-volatile memory, or a volatile memory equipped with a power supply.

Data writing into the component non-volatile memories PM1 through PMn may have an adverse effect on the CPU 81 when performed at timing at which a computation processing speed of the CPU 81 is required, such as the timing while the image forming apparatus 10 is performing a printing operation. In addition, when writing into the component non-volatile memories PM1 through PMn is performed at timing while the door or the cover is open, there is a risk that the component that needs replacing is removed by the user during the writing operation and access between the CPU 81 and the component non-volatile memories PM1 through PMn is cut off, which gives rise to a writing mistake in the component non-volatile memories PM1 through PMn. The writing timing is therefore crucial for the writing of information into the component non-volatile memories PM1 through PMn.

The data writing timing to the component non-volatile memories PM1 through PMn will now be described. To being with, the basic concept will be described.

### (a) Prevention of Influence on Printing Operation

In the typical image forming apparatus 10, the highest processing speed of the CPU 81 is required during a printing operation. Hence, by taking an adverse effect on the printing operation into account, writing into the component non-volatile memories PM1 through PMn and the hard disc during a printing operation should be avoided.

### (b) Prevention of Data Writing Error in Component Non-Volatile Memories

Among factors that cause a writing error in the component non-volatile memories PM1 through PMn, a chief factor is the shut OFF of power supply by switching off the power supply switch by an operation of the user. In a case where power supply is shut OFF by an operation on the control panel, it is possible to perform control under which power supply is shut down after data is stored into the component non-volatile memories PM1 through PMn. However, in a case where the power supply switch is switched OFF by the user, power supply is shut OFF forcedly, and there is a possibility that data being written is not stored completely in the component non-volatile memories PM1 through PMn. Also, in a case where the cover or the door is in an open state, there is a possibility that the replaceable components 20n, 30n, 40n, and 70n are removed manually by the user. Hence, because there is a possibility of the occurrence of a writing error in the component non-volatile memories PM1 through PMn when the cover or the door is in an open state, writing while the cover or the door is in an open state should be avoided.

### (C) Preferable Data Writing Timing to Component Non-volatile Memories

From (a) and (b) described above, as is shown in a timing chart of FIG. 4, as timing at which there is no possibility of the occurrence of a writing error in the component non-volatile memories PM1 through PMn and the influence on the computation processing of the CPU 81 is small, the CPU 81 (timing setting means) sets timing T2 immediately before timing T1 at which an error or a service call occurred during a printing operation or a scanning operation is shown on the control panel as the writing timing to the component non-volatile memories PM1 through PMn (hereinafter, referred to as the set timing T2), and further, the CPU 81 (writing instructing means) gives a writing instruction to the component non-volatile memories PM1 through PMn.

At the set timing T2, the image forming apparatus 10 is not performing an operation that requires a speed as fast as the computation speed for the CPU 81, such as a printing operation. In addition, because the image forming apparatus 10 is in a state immediately after it has finished the operation, there is a low possibility that power supply is shut down by the user.

Also, many users open the cover or the door after the operation of the image forming apparatus 10 stops and they see a display informing an error or a service call on the control panel. Hence, there is a low possibility that the cover or the door is in an open state at the set timing T2.

In addition, the set timing T2 is effective not only in the writing into the component non-volatile memories PM1 through PMn, but also in reading the component non-volatile memories PM1 through PMn, bar codes, and sensor information with the use of reading means (not shown), because a possibility of a reading error and a erroneous detection can be reduced.

Writing errors in the component non-volatile memories PM1 through PMn and memory corruptions can be prevented also by reducing the number of writing times per se. Hence, by checking whether information is updated before writing is performed at the set timing T2 and by allowing the writing only when information is updated, it is possible to further enhance the writing safety.

In the event of the occurrence of a writing error when information is being stored into the component non-volatile memories PM1 through PMn, information is temporarily stored into the hard disc (not shown) or the non-volatile memory 84 provided on the main body side for fail safe, and writing into the component non-volatile memories PM1 through PMn is performed again at another timing.

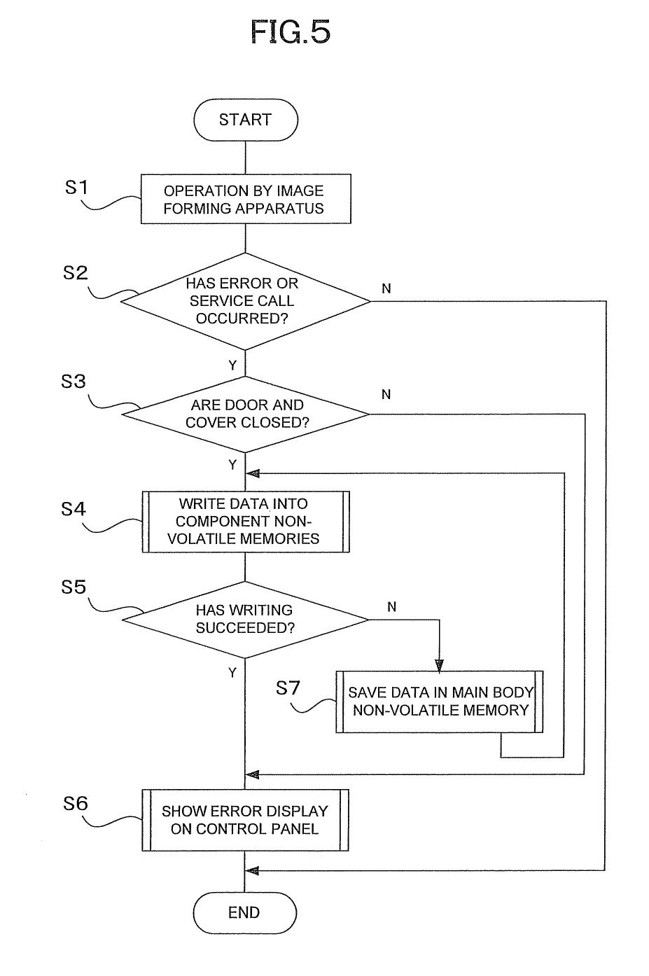

Data writing operations into the component non-volatile memories will now be described with reference to the flowchart of FIG. 5.

Initially, the image forming apparatus 10 is allowed to perform a specific operation, such as a printing operation, while it is powered on (Step S1).

Subsequently, whether the image forming apparatus 10 that is operating gives a display instruction for an error or a service call is determined (Step S2).

In a case where it is found that no display instruction is given as a result of determining whether a display instruction for en error or a service call is given, the image forming apparatus 10 continues the operation in a normal state.

Meanwhile, in a case where it is found that a display instruction is given as a result of determining whether a display instruction for an error or a service call is given, whether the door and the cover are closed is determined (Step S3).

Subsequently, in a case where the door and the cover are determined as being closed, data is written into the component non-volatile memories PM1 through PMn (Step S4)

Subsequently, whether data writing into the component non-volatile memories PM1 through PMn has succeeded is determined (Step S5).

Subsequently, in a case where data writing into the component non-volatile memories PM1 through PMn is determined as having succeeded, a specific error display is performed on the control panel according to the error content (Step S6).

Meanwhile, in a case where data writing into the component non-volatile memories PM1 through PMn is determined as being unsuccessful in Step S5, data for which an attempt was made to be written into the component non-volatile memories PM1 through PMn is written into the main body non-volatile memory 84 to temporarily save the data (Step S7).

The data temporarily saved by being written into the main body non-volatile memory 84 is written into the component non-volatile memories PM1 through PMn again at another timing (Step S4).

Thereafter, a specific error display is performed on the control panel according to the error content by allowing the flowchart to proceed to Step S6 from Step SS.

In the embodiment described above:

(1) when information is written into the component non-volatile memories, timing at which a processing speed as high as computation speed, such as during a printing operation is required is avoided; and

(2) writing into the memories while the door or the cover is in an open state is avoided because when writing into the component non-volatile memories is performed at timing at which the door or the cover is open, a writing mistake in the memories occurs when the user removes the component that needs replacing during the writing operation and access between the computation device and the memory is cut off.

Hence, to satisfy the conditions specified above, writing into the memory is performed immediately before an error display is shown on the control panel when an error or a service call occurs in the image forming apparatus. At this timing, the image forming apparatus is not performing an operation that requires a high processing speed of the computation device.

Also, because the user opens the door or the cover after an error display is shown on the control panel, it means that neither door nor the cover is open before an error display is shown. In short, there is no risk that a component that needs replacing is removed during the writing into the component non-volatile memory.

According to the foregoing, it is possible to perform the writing processing or the reading processing at timing at which influences on the computation processing are small without causing memory corruption or a writing mistake for the component non-volatile memory equipped to a component of the image forming apparatus that can be removed by the user.

Although exemplary embodiments of the present invention have been shown and described, it will be apparent to those having ordinary skill in the art that a number of changes, modifications, or alterations to the invention as described herein may be made, none of which depart from the sprit of the present invention. All such changes, modifications, and alterations should therefore be seen as within the scope of the present invention.

What is claimed is:

1. An image forming apparatus, comprising:
an image forming process device used to form an image;
a memory that engages with a replaceable component in a component unit forming the image forming process device and stores data about the replaceable component;
timing setting means for setting writing timing at which the data is written into the memory for the data to be stored therein;
writing instructing means for giving an instruction to write the data into the memory at timing set by the timing setting means; and
control means for controlling the image forming process device,
wherein the timing setting means inhibits writing of the data into the memory during an image forming process.

2. An image forming apparatus, comprising:
an image forming process device used to form an image;
a memory that engages with a replaceable component in a component unit forming the image forming process device and stores data about the replaceable component;
timing setting means for setting reading timing at which the data is read out from the memory;
reading instructing means for giving an instruction to read out the data from the memory at timing set by the timing setting means; and
control means for controlling the image forming process device,
wherein the timing setting means inhibits reading of the data from the memory during an image forming process.

3. An image forming apparatus, comprising:
an image forming process device used to form an image;
a memory that engages with a replaceable component in a component unit forming the image forming process device and stores data about the replaceable component;
timing setting means for setting writing timing at which the data is written into the memory for the data to be stored therein;
writing instructing means for giving an instruction to write the data into the memory at timing set by the timing setting means; and
control means for controlling the image forming process device,
wherein the timing setting means sets the timing at which the data is written into the memory for the data to be stored therein to either one of timing immediately after an occurrence of jamming and a service call and timing immediately before an error display.

4. An image forming apparatus, comprising:
an image forming process device used to form an image;
a memory that engages with a replaceable component in a component unit forming the image forming process device and stores data about the replaceable component;
timing setting means for setting reading timing at which the data is read out from the memory;
reading instructing means for giving an instruction to read out the data from the memory at timing set by the timing setting means; and
control means for controlling the image forming process device,
wherein the timing setting means sets the timing at which the data is read out from the memory to either one of timing immediately after an occurrence of jamming and a service call and timing immediately before an error display.

5. The image forming apparatus according to any of claims 1 through 4, wherein:
the image forming apparatus has a structure in which the replaceable component is not removed unless one of a door and a cover thereof is opened.

6. The image forming apparatus according to any of claims 1 through 4, wherein:
the memory is a non-volatile memory.

7. The image forming apparatus according to claim 1 or 3, wherein:
in a case where an access error occurs when the writing instructing means has access to the memory, control to temporarily save data in a memory on an image forming apparatus main body side is performed.

8. The image forming apparatus according to claim 1 or 3, wherein:
whether data to be written into the memory is updated is checked and writing processing into the memory is performed only when the data is updated.

9. The image forming apparatus according to claim 2 or 4, wherein:
in a case where an access error occurs when the reading means has access to the memory, control to temporarily save data in a memory on an image forming apparatus main body side is performed.
